(19) United States
(12) Patent Application Publication
(10) Pub. No.: US 2017/0249707 A1
(43) Pub. Date: Aug. 31, 2017

(54) INTELLIGENT SHARE QUEUING

(71) Applicant: LinkedIn Corporation, Mountain View, CA (US)

(72) Inventor: Dustin Hall Koch, Santa Clara, CA (US)

(21) Appl. No.: 15/056,920

(22) Filed: Feb. 29, 2016

(51) Int. Cl. G06Q 50/00; G06F 17/30

(52) U.S. Cl. CPC G06Q 50/01; G06F 17/3053

(57) ABSTRACT

Techniques for publishing content on the online social network during a determined time interval are described. A publisher can receive, from a device of a user, a first content to publish on an online social network. Additionally, the publisher can access a plurality of first-degree connections associated with the user, and member activity data for the plurality of first-degree connections of the user. The member activity data can include temporal data indicative of time parameters for member connections to the online social network for each first-degree connection. Furthermore, the publisher can determine, using a processor, a first time interval to publish the first content based on the accessed member activity data. Subsequently, the publisher can publish, on the online social network, the first content during the first time interval.

### TECHNICAL FIELD

The subject matter disclosed herein generally relates to the technical field of data processing, specifically, determining optimal timing of publications.

### BACKGROUND

An online social networking service can maintain information on members, companies, organizations, employees, and employers. The online social network may maintain profile pages of members, which can include education information, employment information, and location information about a specific member. Additionally, the online social network can store information about a member's relationships with other members of the online social network. Moreover, a member can publish content to other members using the online social networking service. The published content can be presented on a newsfeed. Often, some published content on the newsfeed may be missed by members due to the timing of the posting.

### BRIEF DESCRIPTION OF THE DRAWINGS

Some embodiments are illustrated by way of example and not limitation in the figures of the accompanying drawings.

FIG. 1 is a network diagram illustrating a network environment suitable for an online social network, according to some example embodiments.

FIG. 2 is a block diagram illustrating various components of an online social network, according to some example embodiments.

FIG. 3 is a flowchart illustrating a method for publishing content on the online social network during a determined time interval, according to some example embodiments.

FIG. 4 is a flowchart illustrating a method for calculating an optimal time to publish content on the online social network, according to some example embodiments.

FIG. 5 is a user interface diagram illustrating a priority list for determining rank of content to publish on the online social network, according to some embodiments.

FIG. 6 is a block diagram illustrating components of a machine, according to some example embodiments, able to read instructions from a machine-readable medium and perform any one or more of the methodologies discussed herein.

### DETAILED DESCRIPTION

The description that follows includes systems, methods, techniques, instruction sequences, and computing machine program products that embody illustrative embodiments. In the following description, for the purposes of explanation, numerous specific details are set forth in order to provide an understanding of various embodiments of the subject matter discussed herein. It will be evident, however, to those skilled in the art, that embodiments of the inventive subject matter may be practiced without these specific details. In general, well-known instruction instances, protocols, structures, and techniques are not necessarily shown in detail.

Examples merely demonstrate possible variations. Unless explicitly stated otherwise, components and functions are optional and may be combined or subdivided, and operations may vary in sequence or be combined or subdivided. In the following description, for purposes of explanation, numerous specific details are set forth to provide a thorough understanding of example embodiments. It will be evident, to one skilled in the art, however, that the present subject matter may be practiced without these specific details.

According to some embodiments, a publisher can publish content, on behalf of a user, on an online social networking service during a time interval in the future. Additionally, the publisher can publish the content on different social networking platforms during different time intervals based on the member's activity in each social networking platform. For example, the publisher can determine a first optimal time interval to publish the content at a first platform, and a second optimal time interval to publish the content at a second platform. The first and second optimal time intervals can be different. The optimal time interval can be calculated based on members' activity data (e.g., like, comment, share, views) on the different platforms. Furthermore, the optimal time interval is calculated based on the activities of members that are directly connected (e.g., first-degree connection) to the user publishing the content.

The member activity data can includes temporal data indicative of time parameters for member connections to the online social network. The temporal data includes a specific time, such as a last login time, an average (e.g., mean, median, mode) login time associated with a member accessing in the online social network. Additionally, the temporal data can include a time period, such as a last period of connection, a duration of a session, a duration of an activity, a duration of a login. Furthermore, the time parameters can be an average (e.g., mean, mode, median) of times a member logs in or their usual duration of activity. The member's login can activity temporal pattern that can be used, during the optimal timing process, more intelligently to accurate determine the optimal time to publish content.

In some instances, the publisher allows a user of the online social network to queue updates, shares, publications, and so on. Additionally, the publisher can access information (e.g., member activity data) from the user's connections to determine the optimal publication time or time interval. For example, the publisher determines the time interval that the user's connections are likely to be accessing the online social network. The optimal time interval can be determined based on the member activity data associated with the user's connections. The member activity data includes usage patterns (e.g., when, how long, last login time) about a user accessing the online social network. The publisher, using the determined optimal time interval, can publish the content on the online social network to a higher number of the user's first-degree connections.

For example, a realtor can request the publisher to share a listing on the online social network at the optimal time to increase the views of the listing. The publisher can use an intelligent share queuing process to access the realtor's network to determine the optimal publication time. The intelligent share queuing process determines when a high number of the realtor's network is active or online, and posts the queued listing for maximum exposure to the realtor's network. The exposure can be calculated using a weighted score of likes, comments, shares, and views.

Furthermore, a user interface can allow members to queue and prioritize multiple posts for the publisher to publish in the future. Additionally, the user interface can allow members to preview posts before publication. For example, the member can preview the post to ensure that a web link (e.g., uniform resource locator (URL)) is still active and that the queued material is still appropriate. Furthermore, the user interface can allow a member to update the priority list and reorder the timing of the posts.

Techniques described herein allow for a publisher to post content based on a targeted audience's activity data for an online social network. For example, the publisher can publish the content for a member at a future time interval at in order to present the content to a greater number of first-degree connections in comparison to presenting the content in real-time. The time interval is calculated based on the member activity data (likes, comments, shares, and views) of the first-degree connections.

Additionally, a user input from a member of the social network can prioritize the content to be published on the online social network using a priority list. In such instances, the publisher can update the time interval based on the priority list.

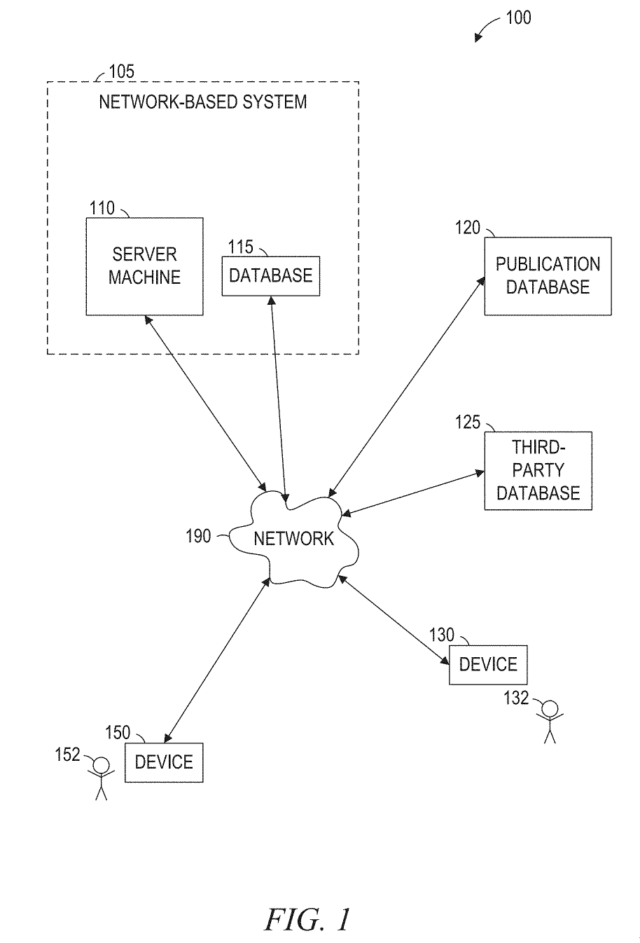

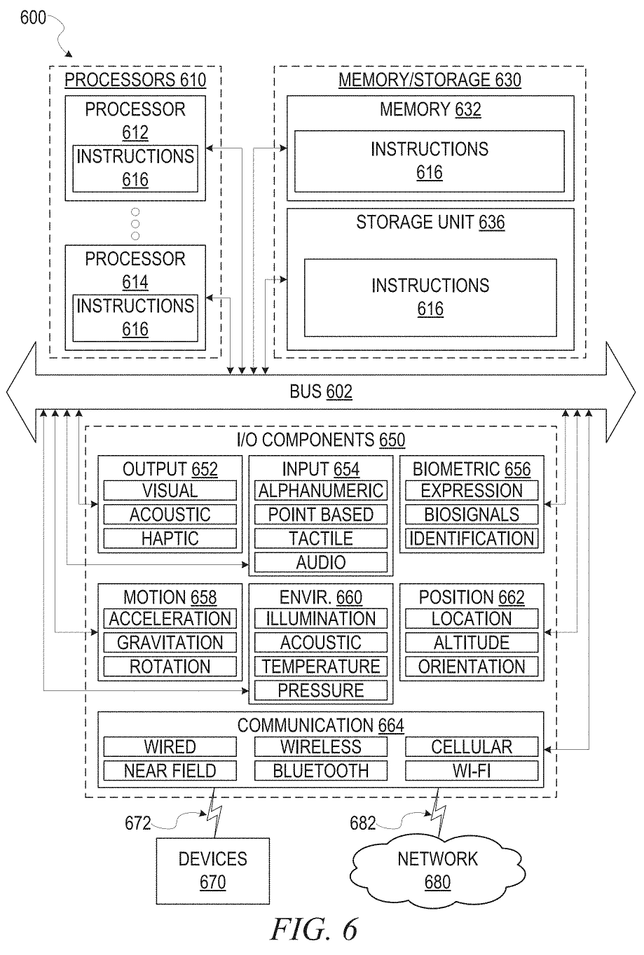

FIG. 1 is a network diagram illustrating a network environment 100 suitable for an online social network service, according to some example embodiments. The network environment 100 includes a server machine 110, a database 115, a third-party database 125, a first device 130 for a first user 132, and a second device 150 for a second user 152, all communicatively coupled to each other via a network 190. The server machine 110 and the database 115 may form all or part of a network-based system 105 (e.g., a cloud-based server system configured to provide one or more services to the devices 130 and 150). The database 115 can store, but is not limited to storing, member data, company data, education data, social graph data, and member activity data for the online social network service. In some instances, the database 115 can include a plurality of databases (e.g., a first database to store profile data, a second database to store social data, a third database to store member activity data). The server machine 110, the first device 130, and the second device 150 may each be implemented in a computer system, in whole or in part, as described below with respect to FIG. 6.

The publication database 120 can store publications (e.g., posts) that have been queued by the publisher in order to be published later. For example, a publisher can determine, using an optimal timing process, a time interval to publish a posting. Then the publication database 120 can store the posting until the posting is published based on the determined time interval. In some instances, the publication database 120 can be part of the network-based system 105. The server machine 110 can access the information in the publication database 120 using the network 190.

The third-party database 125 can store third-party data regarding the member activity of other online social networks. The third-party data can be accessed from other online social networks using publically available information. The server machine 110 can access the information in the third-party database 125 using the network 190.

Also shown in FIG. 1 are the users 132 and 152. One or both of the users 132 and 152 may be a human user (e.g., member of the online social network), a machine user (e.g., a computer configured by a software program to interact with the device 130 or 150), or any suitable combination thereof (e.g., a human assisted by a machine or a machine supervised by a human). The user 132 is not part of the network environment 100, but is associated with the device 130 and may be a user of the device 130. For example, the device 130 may be a desktop computer, a vehicle computer, a tablet computer, a navigational device, a portable media device, a smartphone, or a wearable device (e.g., a smart watch or smart glasses) belonging to the user 132. Likewise, the user 152 is not part of the network environment 100, but is associated with the device 150. As an example, the device 150 may be a desktop computer, a vehicle computer, a tablet computer, a navigational device, a portable media device, a smartphone, or a wearable device (e.g., a smart watch or smart glasses) belonging to the user 152.

In some instances, the user 132 can be the member posting content on the online social network using the publisher. Additionally, the user 152 can be a first-degree connection of the member viewing the content after the publisher has posted it on the online social network. For example, the server machine 110 can receive the content from user 132 and publish the content at a later time using network 190, which can be viewed by the first-degree connections (e.g., user 152) of user 132.

The network 190 may be any network that enables communication between or among machines, databases 115, and devices (e.g., the server machine 110 and the device 130). Accordingly, the network 190 may be a wired network, a wireless network (e.g., a mobile or cellular network), or any suitable combination thereof. The network 190 may include one or more portions that constitute a private network, a public network (e.g., the Internet), or any suitable combination thereof. Accordingly, the network 190 may include one or more portions that incorporate a local area network (LAN), a wide area network (WAN), the Internet, a mobile telephone network (e.g., a cellular network), a wired telephone network (e.g., a plain old telephone system (POTS) network), a wireless data network (e.g., a Wi-Fi network or WiMAX network), or any suitable combination thereof. Any one or more portions of the network 190 may communicate information via a transmission medium. As used herein, “transmission medium” refers to any intangible (e.g., transitory) medium that is capable of communicating (e.g., transmitting) instructions for execution by a machine (e.g., by one or more processors of such a machine), and includes digital or analog communication signals or other intangible media to facilitate communication of such software.

Any of the machines, databases 115, or devices 130, 150 described herein may be implemented in a general-purpose computer modified (e.g., configured or programmed) by software (e.g., one or more software modules) to be a special-purpose computer to perform one or more of the functions described herein for that machine, database 115, or device 130, 150. For example, a computer system able to implement any one or more of the methodologies described herein is discussed below with respect to FIG. 6. As used herein, a “database” is a data storage resource and may store data structured as a text file, a table, a spreadsheet, a relational database (e.g., an object-relational database), a triple store, a hierarchical data store, or any suitable combination thereof. Moreover, any two or more of the machines, databases 115, or devices 130, 150 described herein may be combined into a single machine, database 115, or device 130, 150, and the functions described herein for any single machine, database 115, or device 130, 150 may be subdivided among multiple machines, databases 115, or devices 130, 150.

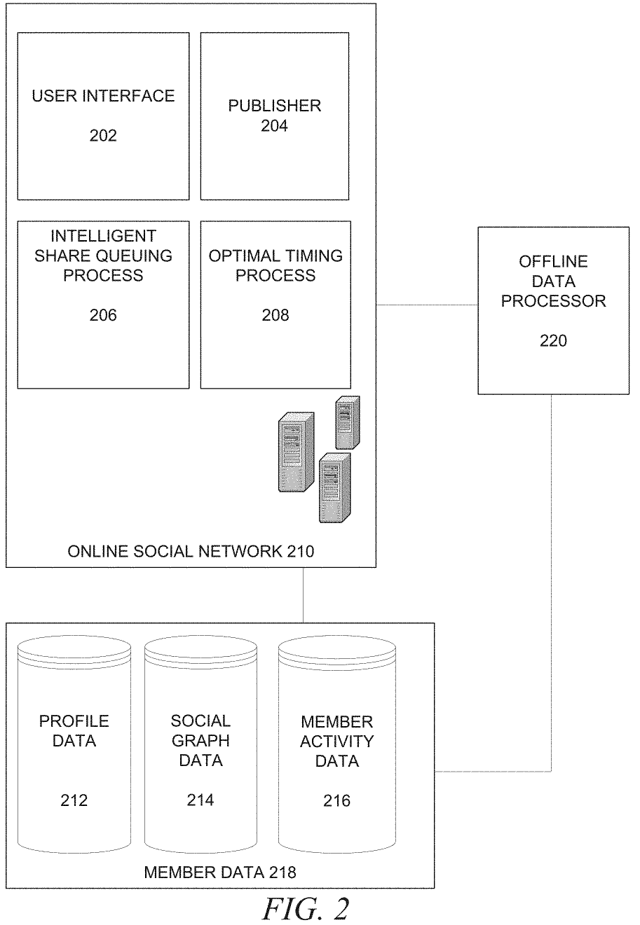

FIG. 2 is a block diagram illustrating components of an online social network 210, according to some example embodiments. The online social network 210 is an example of a network-based system 105 of FIG. 1. The online social network 210 can include a user interface 202, a publisher 204, an intelligent share queuing process 206, an optimal timing process 208, all configured to communicate with each other (e.g., via a bus, shared memory, or a switch). The user interface 202 can provide information or cause an interface to be rendered on a client device of the member.

Additionally, the online social network 210 can communicate with the database 115 of FIG. 1, such as a database storing member data 218. Furthermore, the online social network 210 can communicate with the publication database 120 and the third-party database 125 of FIG. 1.

The member data 218 can include profile data 212. Moreover, the member data 218 can include social graph data 214, and member activity data 216. Using the member data 218, the publisher 204 can determine an optimal time interval to publish content on the online social network 210. In some instances, some of the processing of the data for determining the optimal time can be performed by an offline data processor 220 on a periodic basis (e.g., nightly) in order to return faster results.

The profile data 212 include information available in a member's profile page, such as a member's personal and employment information. For instance, with many online social network services, when a user 132, 152 registers to become a member, the member is prompted to provide a variety of personal and employment information that may be displayed in a member's profile page. Such information is commonly referred to as profile data 212. The profile data 212 that is commonly requested and displayed as part of a member's profile includes the member's age, birthdate, gender, interests, contact information, residential address, home town and/or state, spouse's and/or family members' names, educational background (e.g., schools, majors, matriculation and/or graduation dates, etc.), employment history, job title, job industry, office location, skills, professional organizations, and so on. In some embodiments, the profile data 212 may include the various skills that each member has indicated he or she possesses. Additionally, the profile data 212 may include skills of a member that have been endorsed by another member.

With certain online social network services, such as professional network services, the profile data 212 can include employment information commonly included in a professional resume or curriculum vitae. The employment information can include a person's credentials (e.g., education), the company at which a person is employed, the location of the employer, an industry in which a person is employed, a job title or function, an employment history, skills possessed by a person, professional organizations of which a person is a member, and so on.

Additionally, the online social network 210 provide its users 132, 152 with a mechanism for defining their relationships with other people. This digital representation of real-world relationships is frequently referred to as a social graph, which may be stored in the social graph data 214. The social graph data 214 of a member can include first-degree connections, second-degree connections, and so on.

In some instances, the social graph data 214 can be based on an entity's presence within the online social network service. For example, consistent with some embodiments, a social graph is implemented with a specialized graph data structure in which various entities (e.g., people, companies, schools, government institutions, non-profits, and other organizations) are represented as nodes connected by edges, where the edges have different types representing the various associations and/or relationships between the different entities.

Furthermore, the social graph data 214 may be maintained by a third-party social network service. For example, users 132, 152 can indicate a relationship or association with a variety of real-world entities and/or objects.

In addition to hosting a vast amount of social graph data 214, the online social network 210 maintains member activity data 216.

Typically, a user input is captured when a user 132, 152 interacts with a particular graphical user interface element, such as a button, which is generally presented in connection with the particular entity or object and frequently labelled in some meaningful way (e.g., “like,” “+1,” “follow”). The user interaction with the online social network 210 can be captured and stored as member activity data 216.

The member activity data 216 can include members' interaction with the various applications, services, and content made available via the online social network 210, and the members' behavior (e.g., content viewed, links selected, etc.) can be used by the optimal timing process 208 to determine the time interval for publishing content.

Furthermore, the online social network 210 can be configured to process data offline or periodically using the offline data processor 220. In some instances, some or all of the optimal timing process 208 can be performed by the offline data processor 220. For example, the offline data processor 220 can include Hadoop servers that access the member activity data 216 periodically (e.g., on a nightly basis) to predetermine the time intervals for publishing content.

Determining the optimal timing interval to publish content may be computationally intensive; therefore, due to hardware limitations and to ensure reliable performance of the online social network 210, some determination or calculation by the optimal timing process 208 may be done offline. For example, the member data 218 may be processed in the background or offline.

Additionally, the publisher 204 can present, to a user 132, the content in order for the user 132 to verify the content. For example, the user 132 may want to ensure that the content, such as web links, are still valid before posting the content.

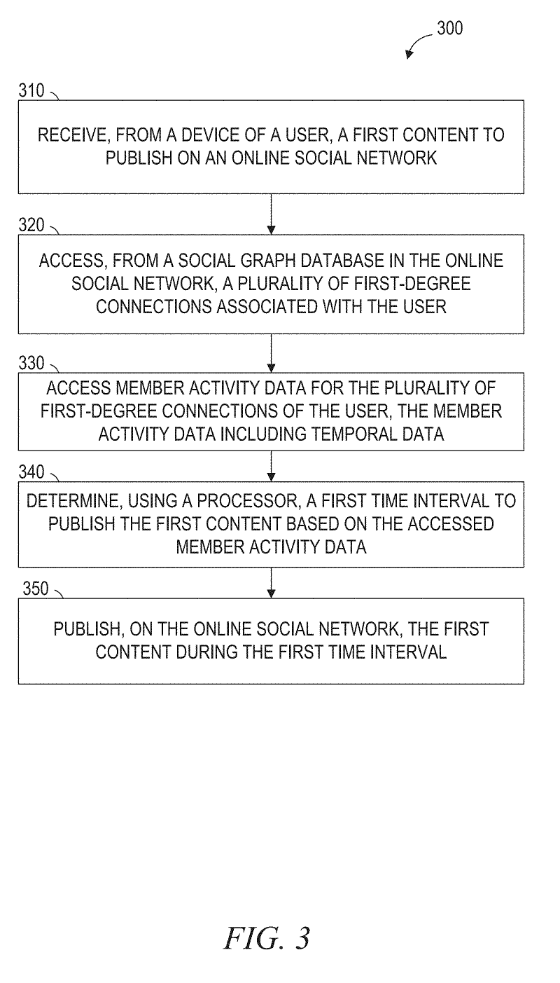

As will be further described with respect to FIGS. 3-5, the publisher 204, in conjunction with the user interface 202, the intelligent share queuing process 206, and the optimal timing process 208, can publish content at a determined time interval in the future.

FIG. 3 is a flowchart illustrating operations of the network-based system 105 in performing a method 300 for publishing content on the online social network 210 during a determined time interval, according to some example embodiments. Operations in the method 300 may be performed by the online social network 210, using the user interface 202, the publisher 204, the intelligent share queuing process 206, and optimal timing process 208 as described above with respect to FIG. 2. As shown in FIG. 3, the method 300 includes operations 310, 320, 330, 340, and 350.

At operation 310, the publisher 204 receives first content to publish on the online social network 210. For example, the user 132, using device 130, can transmit the first content to the online social network 210. The first content can be sent using the network 190. In some instances, the first content can include a publication, a posting, a picture, and so on. The first content can include anything that can be published on the newsfeed of the online social network 210. The first content can be transmitted and received using communication components (e.g., communication components 664 of FIG. 6).

Additionally, the user interface 202 allows for the user 132 to queue multiple posts at a time. Furthermore, the user 132 can preview a post (e.g., to ensure URLs are still active and queued material is still appropriate), and allow the user 132 to reorder the priority of each post by updating the priority list.

At operation 320, the optimal timing process 208 can access a plurality of first-degree connections associated with the user 132. For example, the plurality of first-degree connections is accessed from the social graph data 214 in the online social network 210. As previously mentioned, the social graph data 214 includes the first-degree connections and the second-degree connections of each user 132. In some instances, the social graph database can be stored in the database 115 of FIG. 1.

By analyzing the member activity data 216 of the first-degree connections of the user 132, the optimal timing process 208 can determine the optimal time interval that is specific to each user 132, 152.

At operation 330, the optimal timing process 208 can access member activity data 216 for the plurality of first-degree connections of the user 132. The member activity data 216 stored in the online social network 210 is an example of the member activity data 216 accessed at operation 330. Additionally, the member activity data 216 includes temporal data indicative of time parameters for member connections to the online social network. The temporal data includes the last login time, the last period of connection, an average (e.g., mean, median) login time associated with a member accessing in the online social network 210. The last login time is the time and date that a user 132, 152 accessed the online social network 210. Depending on the circumstance, the average login time may be a more accurate prediction of a future time that a member logs into the online social network 210. For example, a member may usually login around 1:00 PM, but the last login time can be 5:00 PM, which is unusual. In some instances, the member activity database can be stored in the database 115 of FIG. 1.

As previously mentioned, the member activity data 216 includes member activity on the online social network 210 during each online session. An online session occurs when a user (e.g., user 132) accesses or logs into the online social network 210. For example, the member activity data 216 includes the time of each online session, the date of each online session, the duration of each online session, the average duration of the online sessions, the number of online session over a predetermined range of time (e.g., daily, weekly, monthly), the number of likes during each session, the number of shares during each session, and the number of views during each session. A share includes when a user 132 re-posts the posting of another member. A view includes when a user 132 views a video posted on the online social network 210.

In some instances, the method 300 can further include the optimal timing process 208 accessing publication data from the publication database 120. For example, the publication data includes other content already queued to be published at a specific time interval on the online social network 210. The specific time interval associated with the other content can be used to determine the optimal time interval to publish the first content at operation 340. The publisher 204 determines the optimal time interval based on the specific time interval associated with the other content, in order to prevent too many postings being publish in one time interval.

In some instances, the method 300 can further include the optimal timing process 208 accessing third-party data from the third-party database 125. For example, the third-party data includes publically available data of other online social networks 210. The third-party data includes non-private posts on other online social networks 210 that are accessible by the public. In some instances, the publisher 204 can determine a third-party time interval to publish the first content on another online social network 210 based on the third-party data. As previously mentioned, the first content can be published during different time intervals depending on the online social network 210 that the post is being published on.

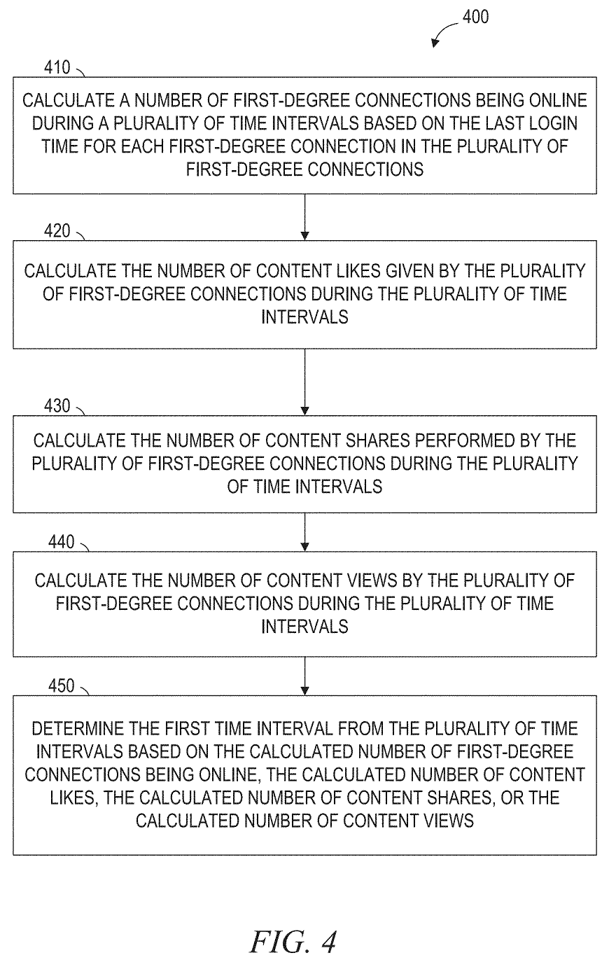

At operation 340, the optimal timing process 208 determines, using a processor, a first time interval to publish the first content based on the member activity data 216 accessed at operation 330. For example, the duration of the time interval can be half an hour, an hour, or any other increment of time. A processor in the server machine 110 can perform the determination in real-time. In some instances, part of the determination at operation 340 can be performed offline using the offline data processor 220. FIG. 4 further describes techniques for determining the first time interval at operation 340.

In some instances, the publisher 204 can access other posting times for other content to be published on the online social network 210. Additionally, the determining of the first time interval can be further based on the other posting times.

In some instances, determining the optimal time interval includes accessing other publications being published on the online social network 210, ranking the first content based on a comparison with the other publications. Subsequently, the determining of the first time interval is further based on the ranking of the first content.

At operation 350, the publisher 204 publishes, on the online social network 210, the first content during the first time interval. As previously mentioned, the first time interval is determined at operation 340. The publisher 204 can publish the first content at the beginning, middle, or any other fraction of the time interval. For example, if the time interval is one hour long, then the first content can be published at the beginning of the hour, at half past the hour, at a quarter past the hour, and so on.

In some instances, the method 300 can further include the user interface 202 causing a presentation of the first content on a display of a device (e.g., device 130, device 150). The presentation can include the first content and a notification that it is a delayed post.

In some instances, the method 300 can further include determining a subset of the first-degree connections to publish the first content. Additionally, the publisher 204 determines an updated first time interval to publish the first content based on the accessed member activity data 216 of the subset, and publishes the first content during the updated first time interval to the subset of the first-degree connections. The subset can be determined based on a user input. For example, the user 132 can select to publish the first content to all first-degree connections that are engineers and that live in San Francisco.

Continuing with the example above, the publisher 204 can determine a job industry associated with the first content by analyzing the first content, and determine the subset based on the determined job industry. For example, the first content can be a job post by a recruiter for a consulting job. The publisher 204 can determine that the job industry for the job post is consulting, and publish the job post on the news feed of the recruiter's first-degree connections that are consultants.

Similarly, the publisher 204 can determine a job title or location associated with the first content by analyzing the first content. When a job title or location is determined based on the analysis of the first content, the subset can be determined based on the job title or the location.

According to some embodiments, the method 300 can further include receiving second content for publication on a second online social network 210. Additionally, the publisher 204 can determine a second time interval to publish the second content based on member activity data 216 from the second online social network 210. Subsequently, the publisher 204 can publish, on the second online social network 210, the second content during the determined second time interval.

FIG. 4 is a flowchart illustrating operations of the online social network 210 in performing a method 400 for determining the optimal time interval to publish the first content, according to some example embodiments. As previously mentioned, the determining of the optimal time interval is also performed at operation 340 of FIG. 3. Operations in the method 400 may be performed by the online social network 210, using the publisher 204, the intelligent share queuing process 206, and the optimal timing process 208 described above with respect to FIG. 2. As shown in FIG. 4, the method 400 includes operations 410, 420, 430, 440, and 450.

At operation 410, the optimal timing process 208 can calculate a number of first-degree connections online during a plurality of time intervals. The number of first-degree connection online is calculated based on the last login time for each first-degree connection in the plurality of first-degree connections. In some instances, a first-degree connection is online when the first-degree connection is logged into the online social network 210. For example, when the last login time for a first-degree connection is Monday at 9:30 AM, then the count for the number of first-degree connections having an online session on Monday between 9 AM and 10 AM is incremented by one.

At operation 420, the optimal timing process 208 can further derive other information from the member activity data 216. The other information used to determine the first time interval can include the time of each online session, the date of each online session, the duration of each online session, the average duration of the online sessions, the number of online session over a predetermined range of time (e.g., daily, weekly, monthly), the number of likes during each online session, the number of shares during each online session, and the number of views during each online session. As previously mentioned, an online session occurs when a user (e.g., user 132) is online and logs into the online social network 210.

In some instances, the optimal timing process 208 can calculate the number of content likes (i.e., likes) given by the plurality of first-degree connections during the plurality of time intervals at operation 420. For example, the number of content likes can be calculated for each time interval in the plurality of time intervals. The content likes can be calculated by summing of the total number of content likes from all of the user 132's first-degree connection in a time interval.

At operation 430, the optimal timing process 208 can calculate the number of content shares performed by the plurality of first-degree connections during the plurality of time intervals. For example, a first-degree connection performs a content share when a posting published on the online social network 210 by another member is re-shared on the online social network 210 by the first-degree connection. The content shares can be calculated by summing the total number of content shares from all of the user 132's first-degree connections in a time interval.

At operation 440, the optimal timing process 208 can calculate the number of content views by the plurality of first-degree connections during the plurality of time intervals. For example, a first-degree connection views content published on the online social network 210 when the first-degree connection clicks on a file (e.g., audio, video, publication) to open and view the file. The content views can be calculated by summing of the total number of content views from all of the user 132's first-degree connection in a time interval.

At operation 450, the optimal timing process 208 determines the first time interval from the plurality of time intervals based on the calculated number of first-degree connections being online, the calculated number of content likes, the calculated number of content shares, or the calculated number of content views. In some instances, one or more of the calculated numbers from operations 410-440 are used to determine the first time interval.

In some instances, the publisher 204 can present, on a display of the device 132, a graph associated with the first time interval. For example, the publisher 204 can present a histogram of the numbers calculated in method 400 for the different time intervals. The graph can illustrate to the user 132 the data behind the determination of the first, second, or third time interval.

For example, the time interval having the highest number of first-degree connections being online, the highest number of content likes, the highest number of content shares, or the highest number of content views in comparison to the other time intervals in the plurality of time intervals can be selected as the first time interval.

Additionally, when a specific time interval having the highest number of content likes, content shares, or content views has already been reserved for publishing other content, then the first time interval can be selected based on having the second highest calculated number (e.g., of content likes, content shares, content views), the third highest calculated number, and so on.

As previously mentioned, the determined first time interval is used at operation 350 of FIG. 3 to publish the first content during the determined time interval.

In some instances, the publisher 204 can receive second content for publication on the online social network 210. The publisher 204 can determine a second time interval to publish the second content using the techniques described in method 400. Additionally, the second time interval can be based on the assessed member activity data 216 and the first time interval. The second time interval can be different from the first time interval. For example, the first time interval has the highest number of content likes calculated using method 400, and the second time interval can have the second highest calculated number of content likes. Subsequently, the publisher 204 publishes the second content during the determined second time interval.

Furthermore, the publisher 204 can receive third content for publication on the online social network 210. The publisher 204 can determine a third time interval based on the accessed member activity data 216, the first time interval, and the second time interval.

Continuing with the example above, the publisher 204 can receive a priority list, the priority list ranking the first content, the second content, and the third content. The publisher 204, using the intelligent share queuing process 206, can determine the first time interval, the second time interval, and the third time interval based on the priority list.

Additionally, the publisher 204 can receive an updated priority list, the updated priority list changing the ranking of the first content, the second content, and the third content. Moreover, the publisher 204, using the intelligent share queuing process 206, can update the first time interval, the second time interval, and the third time interval based on the updated priority list.

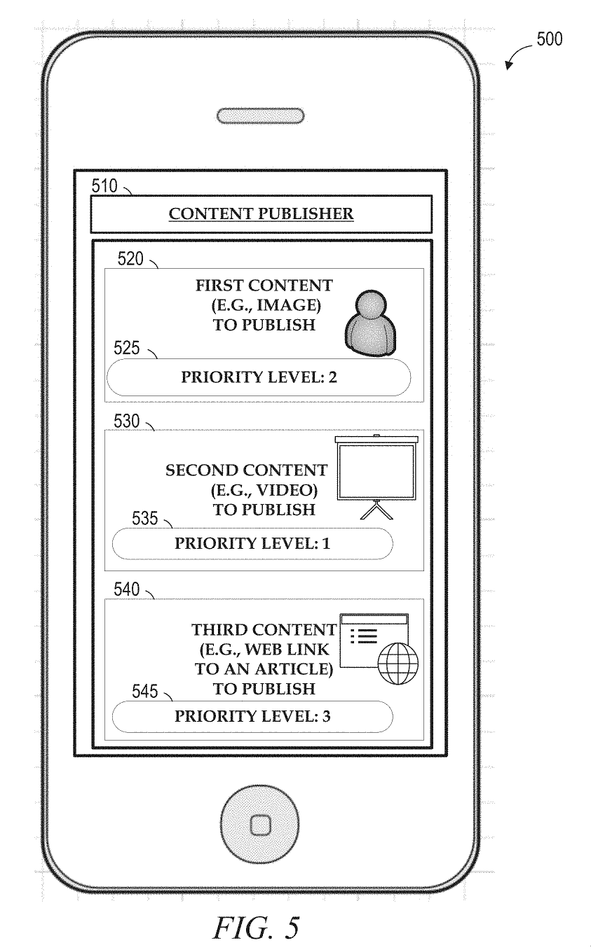

FIG. 5 is a user interface diagram illustrating the priority list and updating the priority list, according to some embodiments.

A user interface 500 in FIG. 5 presents a content publisher 510 to send first, second, and third content to the publisher 204 to publish on the online social network 210. The user interface 500 is an example of the user interface 202 as described in FIG. 2. In some instances, the user 132 can generate first content 520, second content 530, and third content 540 to publish on the online social network 210. In this example, the first content 520 is an image of the user 132, the second content 530 is a video posted by the user 132, and the third content 540 is a web link to an article.

Additionally, the user 132 can select, using user interface 500, a priority ranking for each piece of content. In this example, the second content 530 has a high priority level 535 (e.g., priority level 1), the first content 520 has a medium priority level 525 (e.g., priority level 2), and the third content 540 has a low priority level 545 (e.g., priority level 3).

Furthermore, as described above, the user 132 can update the priority list using the user interface 500. For example, the priority list can be updated by changing the priority level for specific content. The priority level can be changed any time before the content is published. Based on the updated priority list, the intelligent share queuing process 206 can update the time interval to publish the content.

According to various example embodiments, one or more of the methodologies described herein facilitate a wider audience distribution of content published by a user 132. Additionally, based on the database structure illustrated in FIG. 2, the time interval is calculated in real-time by using the offline data processor 220 for some calculations. For example, the online social network 210 can use the offline data processor 220 for the optimal timing process 208, in such a way as to allow an efficient retrieval and processing of the information in order to determine the optimal time interval in real-time.

When these effects are considered in aggregate, one or more of the methodologies described herein may obviate a need for certain human efforts or resources that otherwise would be involved in publishing a posting at a later date. Furthermore, computing resources used by one or more machines, databases 115, or devices 130, 150 (e.g., within the network environment 100) may similarly be reduced (e.g., by pre-determining rankings of experts). Examples of such computing resources include processor cycles, network traffic, memory usage, data storage capacity, power consumption, and cooling capacity.

### Example Machine Architecture and Machine-Readable Medium

FIG. 6 is a block diagram illustrating components of a machine 600, according to some example embodiments, able to read instructions from a machine-readable medium (e.g., a machine-readable storage medium) and perform any one or more of the methodologies discussed herein. Specifically, FIG. 6 shows a diagrammatic representation of the machine 600 in the example form of a computer system, within which instructions 616 (e.g., software, a program, an application, an applet, an app, or other executable code) for causing the machine 600 to perform any one or more of the methodologies discussed herein may be executed. For example, the instructions 616 may cause the machine 600 (e.g., publisher 204 of FIG. 2) to execute the flow diagrams of FIGS. 3 and 4. Additionally, or alternatively, the instructions 616 may implement the intelligent share queuing process 206, or the optimal timing process 208 of FIG. 2, and so forth. The instructions 616 transform the general, non-programmed machine 600 into a particular machine programmed to carry out the described and illustrated functions in the manner described. In alternative embodiments, the machine 600 operates as a standalone device or may be coupled (e.g., networked) to other machines. In a networked deployment, the machine 600 may operate in the capacity of a server machine 110 or a client machine in a server-client network environment, or as a peer machine in a peer-to-peer (or distributed) network environment. The machine 600 may comprise, but not be limited to, a server computer, a client computer, a personal computer (PC), a tablet computer, a laptop computer, a netbook, a set-top box (STB), a personal digital assistant (PDA), an entertainment media system, a cellular telephone, a smart phone, a mobile device, a wearable device (e.g., a smart watch), a smart home device (e.g., a smart appliance), other smart devices, a web appliance, a network router, a network switch, a network bridge, or any machine capable of executing the instructions 616, sequentially or otherwise, that specify actions to be taken by the machine 600. Further, while only a single machine 600 is illustrated, the term “machine” shall also be taken to include a collection of machines 600 that individually or jointly execute the instructions 616 to perform any one or more of the methodologies discussed herein.

The machine 600 may include processors 610, memory/storage 630, and I/O components 650, which may be configured to communicate with each other such as via a bus 602. In an example embodiment, the processors 610 (e.g., a central processing unit (CPU), a reduced instruction set computing (RISC) processor, a complex instruction set computing (CISC) processor, a graphics processing unit (GPU), a digital signal processor (DSP), an application specific integrated circuit (ASIC), a radio-frequency integrated circuit (RFIC), another processor 610, or any suitable combination thereof) may include, for example, a processor 612 and a processor 614 that may execute the instructions 616. The term “processor” is intended to include multi-core processors 610 that may comprise two or more independent processors 612, 614 (sometimes referred to as “cores”) that may execute instructions 616 contemporaneously. Although FIG. 6 shows multiple processors 610, the machine 600 may include a single processor 612 with a single core, a single processor 612 with multiple cores (e.g., a multi-core processor), multiple processors 612, 614 with a single core, multiple processors 612, 614 with multiples cores, or any combination thereof.

The memory/storage 630 may include a memory 632, such as a main memory, or other memory storage, and a storage unit 636, both accessible to the processors 610 such as via the bus 602. The storage unit 636 and memory 632 store the instructions 616 embodying any one or more of the methodologies or functions described herein. The instructions 616 may also reside, completely or partially, within the memory 632, within the storage unit 636, within at least one of the processors 610 (e.g., within the processor's cache memory), or any suitable combination thereof, during execution thereof by the machine 600. Accordingly, the memory 632, the storage unit 636, and the memory of processors 610 are examples of machine-readable media.

As used herein, “machine-readable medium” means a device 130, 150 able to store instructions 616 and data temporarily or permanently and may include, but is not limited to, random-access memory (RAM), read-only memory (ROM), buffer memory, flash memory, optical media, magnetic media, cache memory, other types of storage (e.g., erasable programmable read-only memory (EEPROM)), and/or any suitable combination thereof. The term “machine-readable medium” should be taken to include a single medium or multiple media (e.g., a centralized or distributed database, or associated caches and servers) able to store the instructions 616. The term “machine-readable medium” shall also be taken to include any medium, or combination of multiple media, that is capable of storing instructions (e.g., instructions 616) for execution by a machine (e.g., machine 600), such that the instructions 616, when executed by one or more processors of the machine 600 (e.g., processors 610), cause the machine 600 to perform any one or more of the methodologies described herein. Accordingly, a “machine-readable medium” refers to a single storage apparatus or device 130, 150, as well as “cloud-based” storage systems or storage networks that include multiple storage apparatus or devices 130, 150. The term “machine-readable medium” excludes signals per se.

The I/O components 650 may include a wide variety of components to receive input, provide output, produce output, transmit information, exchange information, capture measurements, and so on. The specific I/O components 650 that are included in a particular machine 600 will depend on the type of machine 600. For example, portable machines such as mobile phones will likely include a touch input device or other such input mechanisms, while a headless server machine will likely not include such a touch input device. It will be appreciated that the I/O components 650 may include many other components that are not shown in FIG. 6. The I/O components 650 are grouped according to functionality merely for simplifying the following discussion and the grouping is in no way limiting. In various example embodiments, the I/O components 650 may include output components 652 and input components 654. The output components 652 may include visual components (e.g., a display such as a plasma display panel (PDP), a light emitting diode (LED) display, a liquid crystal display (LCD), a projector, or a cathode ray tube (CRT)), acoustic components (e.g., speakers), haptic components (e.g., a vibratory motor, resistance mechanisms), other signal generators, and so forth. The input components 654 may include alphanumeric input components (e.g., a keyboard, a touch screen configured to receive alphanumeric input, a photo-optical keyboard, or other alphanumeric input components), point based input components (e.g., a mouse, a touchpad, a trackball, a joystick, a motion sensor, or other pointing instruments), tactile input components (e.g., a physical button, a touch screen that provides location and/or force of touches or touch gestures, or other tactile input components), audio input components (e.g., a microphone), and the like.

In further example embodiments, the I/O components 650 may include biometric components 656, motion components 658, environmental components 660, or position components 662, among a wide array of other components. For example, the biometric components 656 may include components to detect expressions (e.g., hand expressions, facial expressions, vocal expressions, body gestures, or eye tracking), measure biosignals (e.g., blood pressure, heart rate, body temperature, perspiration, or brain waves), identify a person (e.g., voice identification, retinal identification, facial identification, fingerprint identification, or electroencephalogram based identification), and the like. The motion components 658 may include acceleration sensor components (e.g., accelerometer), gravitation sensor components, rotation sensor components (e.g., gyroscope), and so forth. The environmental components 660 may include, for example, illumination sensor components (e.g., photometer), temperature sensor components (e.g., one or more thermometers that detect ambient temperature), humidity sensor components, pressure sensor components (e.g., barometer), acoustic sensor components (e.g., one or more microphones that detect background noise), proximity sensor components (e.g., infrared sensors that detect nearby objects), gas sensors (e.g., gas detection sensors to detect concentrations of hazardous gases for safety or to measure pollutants in the atmosphere), or other components that may provide indications, measurements, or signals corresponding to a surrounding physical environment. The position components 662 may include location sensor components (e.g., a Global Position System (GPS) receiver component), altitude sensor components (e.g., altimeters or barometers that detect air pressure from which altitude may be derived), orientation sensor components (e.g., magnetometers), and the like.

Communication may be implemented using a wide variety of technologies. The I/O components 650 may include communication components 664 operable to couple the machine 600 to a network 680 or devices 670 via a coupling 682 and a coupling 672 respectively. For example, the communication components 664 may include a network interface component or other suitable device 130, 150 to interface with the network 680. In further examples, the communication components 664 may include wired communication components, wireless communication components, cellular communication components, near field communication (NFC) components, Bluetooth® components (e.g., Bluetooth® Low Energy), Wi-Fi® components, and other communication components to provide communication via other modalities. The devices 670 may be another machine or any of a wide variety of peripheral devices (e.g., a peripheral device coupled via a Universal Serial Bus (USB)).

Moreover, the communication components 664 may detect identifiers or include components operable to detect identifiers. For example, the communication components 664 may include radio frequency identification (RFID) tag reader components, NFC smart tag detection components, optical reader components (e.g., an optical sensor to detect one-dimensional bar codes such as Universal Product Code (UPC) bar code, multi-dimensional bar codes such as Quick Response (QR) code, Aztec code, Data Matrix, Dataglyph, MaxiCode, PDF417, Ultra Code, UCC RSS-2D bar code, and other optical codes), or acoustic detection components (e.g., microphones to identify tagged audio signals). In addition, a variety of information may be derived via the communication components 664, such as location via Internet Protocol (IP) geolocation, location via Wi-Fi® signal triangulation, location via detecting an NFC beacon signal that may indicate a particular location, and so forth.

### Transmission Medium

In various example embodiments, one or more portions of the network 680 may be an ad hoc network, an intranet, an extranet, a virtual private network (VPN), a local area network (LAN), a wireless LAN (WLAN), a wide area network (WAN), a wireless WAN (WWAN), a metropolitan area network (MAN), the Internet, a portion of the Internet, a portion of the public switched telephone network (PSTN), a plain old telephone service (POTS) network, a cellular telephone network, a wireless network, a Wi-Fi® network, another type of network, or a combination of two or more such networks. For example, the network 680 or a portion of the network 680 may include a wireless or cellular network and the coupling 682 may be a Code Division Multiple Access (CDMA) connection, a Global System for Mobile communications (GSM) connection, or another type of cellular or wireless coupling. In this example, the coupling 682 may implement any of a variety of types of data transfer technology, such as Single Carrier Radio Transmission Technology (1×RTT), Evolution-Data Optimized (EVDO) technology, General Packet Radio Service (GPRS) technology, Enhanced Data rates for GSM Evolution (EDGE) technology, third Generation Partnership Project (3GPP) including 3G, fourth generation wireless (4G) networks, Universal Mobile Telecommunications System (UMTS), High Speed Packet Access (HSPA), Worldwide Interoperability for Microwave Access (WiMAX), Long Term Evolution (LTE) standard, others defined by various standard-setting organizations, other long-range protocols, or other data transfer technology.

The instructions 616 may be transmitted or received over the network 680 using a transmission medium via a network interface device (e.g., a network interface component included in the communication components 664) and utilizing any one of a number of well-known transfer protocols (e.g., hypertext transfer protocol (HTTP)). Similarly, the instructions 616 may be transmitted or received using a transmission medium via the coupling 672 (e.g., a peer-to-peer coupling) to the devices 670. The term “transmission medium” shall be taken to include any intangible medium that is capable of storing, encoding, or carrying the instructions 616 for execution by the machine 600, and includes digital or analog communications signals or other intangible media to facilitate communication of such software.

### Examples

Example 1 is a method comprising: receiving, from a device of a user, a first content to publish on an online social network; accessing, from a social graph database in the online social network, a plurality of first-degree connections associated with the user; accessing member activity data for the plurality of first-degree connections of the user, the member activity data including temporal data indicative of time parameters for member connections to the online social network; determining, using a processor, a first time interval to publish the first content based on the accessed member activity data; and publishing, on the online social network, the first content during the first time interval.

Example 2 includes the method of Example 1, wherein the determining the first time interval includes: calculating a number of first-degree connections being online during a plurality of time intervals based on the temporal data for each first-degree connection in the plurality of first-degree connections; and determining the first time interval from the plurality of time intervals based on the calculated number of first-degree connections being online.

Example 3 includes the methods of the above examples, wherein the calculated number of first-degree connections being online in the first time interval is higher than the calculated number of first-degree connections being online in other time intervals in the plurality of time intervals.

Example 4 includes the methods of the above examples, further comprising: receiving a second content for publication on the online social network; determining a second time interval to publish the second content based on the assessed member activity data and the first time interval, the second time interval being different from the first time interval; and publishing the second content during the determined second time interval.

Example 5 includes the method of Example 4, further comprising: receiving a priority list, the priority list ranking the first content in relation to the second content; and wherein the determining of the first time interval and the second time interval is further based on the priority list.

Example 6 includes the method of Example 5, further comprising: receiving an updated priority list, the updated priority list changing the ranking of the first content in relation to the second content; and updating the first time interval and the second time interval based on the updated priority list.

Example 7 includes the methods of the above examples, further comprising: accessing other posting times for other content being published on the online social network; and wherein the determining of the first time interval is further based on the other posting times.

Example 8 includes the methods of the above examples, wherein the determining the optimal time interval includes: accessing other publications being published on the online social network; ranking the first content based on a comparison with the other publications; and wherein the determining of the first time interval is further based on the ranking of the first content.

Example 9 includes the methods of the above examples, wherein a duration of the first time interval is an hour.

Example 10 includes the methods of the above examples, further comprising: determining a subset of the first-degree connections to publish the first content; determining an updated first time interval to publish the first content based on the accessed member activity data of the subset; and publishing the first content during the updated first time interval to the subset of the first-degree connections.

Example 11 includes the method of Example 10, wherein the subset is determined based on a user input.

Example 12 includes the method of Example 10, further comprising: determining a job industry associated with the first content by analyzing the first content; and wherein the subset is determined by the job industry.

Example 13 includes the method of Example 10, further comprising: determining a job title associated with the first content by analyzing the first content; and wherein the subset is determined by the job title.

Example 14 includes the method of Example 10, further comprising: determining a location associated with the first content by analyzing the first content; and wherein the subset is determined by the location.

Example 15 includes the methods of the above examples, further comprising: receiving a second content for publication on a second online social network; determining a second time interval to publish the second content based on member activity data from the second online social network; and publishing, on the second online social network, the second content during the determined second time interval.

Example 16 includes the methods of the above examples, further comprising: presenting, on a display of the device, a graph associated with the first time interval.

Example 17 includes the methods of the above examples, wherein the temporal data includes a last login time.

Example 18 includes the methods of the above examples, wherein the temporal data includes an average login time.

Example 19 is an apparatus performing any of the above examples.

Example 20 is the online social network 210 performing of any of the Examples 1-18.

Example 21 is a non-transitory machine-readable storage medium comprising instructions that, when executed by one or more processors of a machine, cause the machine to perform any of the Examples 1-18.

### Language

Throughout this specification, plural instances may implement components, operations, or structures described as a single instance. Although individual operations of one or more methods are illustrated and described as separate operations, one or more of the individual operations may be performed concurrently, and nothing requires that the operations be performed in the order illustrated. Structures and functionality presented as separate components in example configurations may be implemented as a combined structure or component. Similarly, structures and functionality presented as a single component may be implemented as separate components. These and other variations, modifications, additions, and improvements fall within the scope of the subject matter herein.

Although an overview of the inventive subject matter has been described with reference to specific example embodiments, various modifications and changes may be made to these embodiments without departing from the broader scope of embodiments of the present disclosure. Such embodiments of the inventive subject matter may be referred to herein, individually or collectively, by the term “invention” merely for convenience and without intending to voluntarily limit the scope of this application to any single disclosure or inventive concept if more than one is, in fact, disclosed.

The embodiments illustrated herein are described in sufficient detail to enable those skilled in the art to practice the teachings disclosed. Other embodiments may be used and derived therefrom, such that structural and logical substitutions and changes may be made without departing from the scope of this disclosure. The Detailed Description, therefore, is not to be taken in a limiting sense, and the scope of various embodiments is defined only by the appended claims, along with the full range of equivalents to which such claims are entitled.

As used herein, the term “or” may be construed in either an inclusive or exclusive sense. Moreover, plural instances may be provided for resources, operations, or structures described herein as a single instance. Additionally, boundaries between various resources, operations, modules, engines, and data stores are somewhat arbitrary, and particular operations are illustrated in a context of specific illustrative configurations. Other allocations of functionality are envisioned and may fall within a scope of various embodiments of the present disclosure. In general, structures and functionality presented as separate resources in the example configurations may be implemented as a combined structure or resource. Similarly, structures and functionality presented as a single resource may be implemented as separate resources. These and other variations, modifications, additions, and improvements fall within a scope of embodiments of the present disclosure as represented by the appended claims. The specification and drawings are, accordingly, to be regarded in an illustrative rather than a restrictive sense.

Certain embodiments are described herein as including logic or a number of components, modules, or mechanisms. Modules may constitute software modules (e.g., code stored or otherwise embodied on a machine-readable medium or in a transmission medium), hardware modules, or any suitable combination thereof. A “hardware module” is a tangible (e.g., non-transitory) unit capable of performing certain operations and may be configured or arranged in a certain physical manner. In various example embodiments, one or more computer systems (e.g., a standalone computer system, a client computer system, or a server computer system) or one or more hardware modules of a computer system (e.g., a processor 610 or a group of processors 610) may be configured by software (e.g., an application or application portion) as a hardware module that operates to perform certain operations as described herein.

In some embodiments, a hardware module may be implemented mechanically, electronically, or any suitable combination thereof. For example, a hardware module may include dedicated circuitry or logic that is permanently configured to perform certain operations. For example, a hardware module may be a special-purpose processor, such as a field programmable gate array (FPGA) or an ASIC. A hardware module may also include programmable logic or circuitry that is temporarily configured by software to perform certain operations. For example, a hardware module may include software encompassed within a general-purpose processor 610 or other programmable processor 610. It will be appreciated that the decision to implement a hardware module mechanically, in dedicated and permanently configured circuitry, or in temporarily configured circuitry (e.g., configured by software) may be driven by cost and time considerations.

Accordingly, the phrase “hardware module” should be understood to encompass a tangible entity, and such a tangible entity may be physically constructed, permanently configured (e.g., hardwired), or temporarily configured (e.g., programmed) to operate in a certain manner or to perform certain operations described herein. As used herein, “hardware-implemented module” refers to a hardware module. Considering embodiments in which hardware modules are temporarily configured (e.g., programmed), each of the hardware modules need not be configured or instantiated at any one instance in time. For example, where a hardware module comprises a general-purpose processor 610 configured by software to become a special-purpose processor, the general-purpose processor 610 may be configured as respectively different special-purpose processors (e.g., comprising different hardware modules) at different times. Software (e.g., a software module) may accordingly configure one or more processors 610, for example, to constitute a particular hardware module at one instance of time and to constitute a different hardware module at a different instance of time.

Hardware modules can provide information to, and receive information from, other hardware modules. Accordingly, the described hardware modules may be regarded as being communicatively coupled. Where multiple hardware modules exist contemporaneously, communications may be achieved through signal transmission (e.g., over appropriate circuits and buses) between or among two or more of the hardware modules. In embodiments in which multiple hardware modules are configured or instantiated at different times, communications between such hardware modules may be achieved, for example, through the storage and retrieval of information in memory structures to which the multiple hardware modules have access. For example, one hardware module may perform an operation and store the output of that operation in a memory device to which it is communicatively coupled. A further hardware module may then, at a later time, access the memory device to retrieve and process the stored output. Hardware modules may also initiate communications with input or output devices, and can operate on a resource (e.g., a collection of information).

The various operations of example methods described herein may be performed, at least partially, by one or more processors 610 that are temporarily configured (e.g., by software) or permanently configured to perform the relevant operations. Whether temporarily or permanently configured, such processors 610 may constitute processor-implemented modules that operate to perform one or more operations or functions described herein. As used herein, “processor-implemented module” refers to a hardware module implemented using one or more processors 610.

Similarly, the methods described herein may be at least partially processor-implemented, a processor 610 being an example of hardware. For example, at least some of the operations of a method may be performed by one or more processors 610 or processor-implemented modules. As used herein, “processor-implemented module” refers to a hardware module in which the hardware includes one or more processors 610. Moreover, the one or more processors 610 may also operate to support performance of the relevant operations in a “cloud computing” environment or as a “software as a service” (SaaS). For example, at least some of the operations may be performed by a group of computers (as examples of machines 600 including processors 610), with these operations being accessible via a network 680 (e.g., the Internet) and via one or more appropriate interfaces (e.g., an application programming interface (API)).

The performance of certain operations may be distributed among the one or more processors 610, not only residing within a single machine 600, but deployed across a number of machines 600. In some example embodiments, the one or more processors 610 or processor-implemented modules may be located in a single geographic location (e.g., within a home environment, an office environment, or a server farm). In other example embodiments, the one or more processors 610 or processor-implemented modules may be distributed across a number of geographic locations.

Some portions of the subject matter discussed herein may be presented in terms of algorithms or symbolic representations of operations on data stored as bits or binary digital signals within a machine memory (e.g., a computer memory). Such algorithms or symbolic representations are examples of techniques used by those of ordinary skill in the data processing arts to convey the substance of their work to others skilled in the art. As used herein, an “algorithm” is a self-consistent sequence of operations or similar processing leading to a desired result. In this context, algorithms and operations involve physical manipulation of physical quantities. Typically, but not necessarily, such quantities may take the form of electrical, magnetic, or optical signals capable of being stored, accessed, transferred, combined, compared, or otherwise manipulated by a machine 600. It is convenient at times, principally for reasons of common usage, to refer to such signals using words such as “data,” “content,” “bits,” “values,” “elements,” “symbols,” “characters,” “terms,” “numbers,” “numerals,” or the like. These words, however, are merely convenient labels and are to be associated with appropriate physical quantities.

Unless specifically stated otherwise, discussions herein using words such as “processing,” “computing,” “calculating,” “determining,” “presenting,” “displaying,” or the like may refer to actions or processes of a machine 600 (e.g., a computer) that manipulates or transforms data represented as physical (e.g., electronic, magnetic, or optical) quantities within one or more memories 632 (e.g., volatile memory, non-volatile memory, or any suitable combination thereof), registers, or other machine components that receive, store, transmit, or display information. Furthermore, unless specifically stated otherwise, the terms “a” or “an” are herein used, as is common in patent documents, to include one or more than one instance. Finally, as used herein, the conjunction “or” refers to a non-exclusive “or,” unless specifically stated otherwise.

What is claimed is:

1. A method comprising:
receiving, from a device of a user, a first content to publish on an online social network;
accessing, from a social graph database in the online social network, a plurality of first-degree connections associated with the user;
accessing member activity data for the plurality of first-degree connections of the user, the member activity data including temporal data indicative of time parameters for member connections to the online social network;
determining, using a processor, a first time interval to publish the first content based on the accessed member activity data; and
publishing, on the online social network, the first content during the first time interval.

2. The method of claim 1, wherein the determining the first time interval includes:
calculating a number of first-degree connections being online during a plurality of time intervals based on the temporal data for each first-degree connection in the plurality of first-degree connections; and
determining the first time interval from the plurality of time intervals based on the calculated number of first-degree connections being online.

3. The method of claim 1, wherein the calculated number of first-degree connections being online in the first time interval is higher than the calculated number of first-degree connections being online in other time intervals in the plurality of time intervals.

4. The method of claim 1, further comprising:
receiving a second content for publication on the online social network;
determining a second time interval to publish the second content based on the assessed member activity data and the first time interval, the second time interval being different from the first time interval; and
publishing the second content during the determined second time interval.

5. The method of claim 4, further comprising:
receiving a priority list, the priority list ranking the first content in relation to the second content; and
wherein the determining of the first time interval and the second time interval is further based on the priority list.

6. The method of claim 5, further comprising:
receiving an updated priority list, the updated priority list changing the ranking of the first content in relation to the second content; and
updating the first time interval and the second time interval based on the updated priority list.

7. The method of claim 1, further comprising:
accessing other posting times for other content being published on the online social network; and
wherein the determining of the first time interval is further based on the other posting times.

8. The method of claim 1, wherein the determining the optimal time interval includes:
accessing other publications being published on the online social network;
ranking the first content based on a comparison with the other publications; and
wherein the determining of the first time interval is further based on the ranking of the first content.

9. The method of claim 1, wherein a duration of the first time interval is an hour.

10. The method of claim 1, further comprising:
determining a subset of the first-degree connections to publish the first content;
determining an updated first time interval to publish the first content based on the accessed member activity data of the subset; and
publishing the first content during the updated first time interval to the subset of the first-degree connections.

11. The method of claim 10, wherein the subset is determined based on a user input.

12. The method of claim 10, further comprising:
determining a job industry associated with the first content by analyzing the first content; and
wherein the subset is determined by the job industry.

13. The method of claim 10, further comprising:
determining a job title associated with the first content by analyzing the first content; and
wherein the subset is determined by the job title.

14. The method of claim 10, further comprising:
determining a location associated with the first content by analyzing the first content; and
wherein the subset is determined by the location.

15. The method of claim 1, further comprising:
receiving a second content for publication on a second online social network;
determining a second time interval to publish the second content based on member activity data from the second online social network, and
publishing, on the second online social network, the second content during the determined second time interval.

16. The method of claim 1, further comprising:
presenting, on a display of the device, a graph associated with the first time interval.

17. A non-transitory machine-readable storage medium comprising instructions that, when executed by one or more processors of a machine, cause the machine to perform operations comprising:
receiving, from a device of a user, a first content for publication on an online social network;
accessing a plurality of first-degree connections associated with the user;
accessing member activity data for the plurality of first-degree connections of the user, the member activity data including temporal data indicative of time parameters for member connections to the online social network;
determining a first time interval to publish the first content based on the accessed member activity data; and
publishing, on the online social network, the first content during the first time interval.

18. The storage medium of claim 15, further comprising instructions that cause the machine to perform operations comprising:
calculating a number of first-degree connections being online during a plurality of time intervals based on the temporal data for each first-degree connection in the plurality of first-degree connections; and
determining the first time interval from the plurality of time intervals based on the calculated number of first-degree connections being online.

19. The storage medium of claim 15, further comprising instructions that cause the machine to perform operations comprising:
determining a subset of the first-degree connections to publish the first content;
determining an updated first time interval to publish the first content based on the accessed member activity data of the subset; and
publishing the first content during the updated first time interval to the subset of the first-degree connections.

20. An online social network comprising:
a first database having social graph data of the members, the social graph data including first-degree connections of a user in the online social network;
a second database having member activity data, the member activity data including a last login time, content likes, content shares, and content views; and
one or more processors in a publisher to:
receive, from a device of a user, a first content to publish on an online social network;
accessing the first-degree connections of the user;
accessing the member activity data for the first-degree connections of the user;
determining a first time interval to publish the first content based on the accessed member activity data; and
publishing, on the online social network, the first content during the first time interval.
